(19) United States
(12) Patent Application Publication
(10) Pub. No.: US 2018/0063887 A1
(43) Pub. Date: Mar. 1, 2018

(54) HEATED PTC ELEMENT WITH PROTECTION CIRCUIT

(71) Applicant: Hamilton Sundstrand Corporation, Charlotte, NC (US)

(72) Inventor: Jon Shearer, Hartville, OH (US)

(21) Appl. No.: 15/254,023

(22) Filed: Sep. 1, 2016

(51) Int. Cl. H05B 1/02; H02H 7/00; B64C 1/18

(52) U.S. Cl. CPC H05B 1/0236; H05B 2203/02; B64C 1/18; H02H 7/008

(57) ABSTRACT

A heater electrical short protection arrangement has a heating layer that is at least partially electrically conductive. A conductive layer is initially electrically insulated from the heating layer. A circuit in electrical communication with the conductive layer is configured to halt a supply of electrical energy to the heating layer in response to current flowing into the conductive layer.

### BACKGROUND OF THE INVENTION

This application relates to a heated PTC element having a fault protection circuit.

Heated floor panels are known and utilized in any number of applications. One proposed application is in an aircraft cabin. In particular, a location near an aircraft door is being considered to be provided with such panels.

One type of heated floor panel is a positive temperature coefficient (“PTC”) panel. Such panels are formed of a material that heats when provided with electric current. Conductors are interlaced within a substrate of PTC material and current is supplied to the conductors, which, in turn, causes the substrate to heat.

There are concerns with these panels, particularly, as occupants of the aircraft cabin are exposed to the panels. One concern has to do with shock hazards or dielectric breakdown, which can lead to arcing or smoke damage. As an example, if the panel is damaged, the PTC could be compromised.

### SUMMARY OF THE INVENTION

A heater electrical short protection arrangement has a heating layer that is at least partially electrically conductive. A conductive layer is initially electrically insulated from the heating layer. A circuit in electrical communication with the conductive layer is configured to halt a supply of electrical energy to the heating layer in response to current flowing into the conductive layer.

A method is also disclosed.

These and other features may be best understood from the following drawings and specification, the following of which is a brief description.

### BRIEF DESCRIPTION OF THE DRAWINGS

FIG. 1A schematically shows a heated floor panel in an aircraft.

FIG. 1B shows a safety circuit.

FIG. 2 shows an example of damage to a panel.

FIG. 3 shows a first location for the safety circuit.

FIG. 4 shows an alternative location.

### DETAILED DESCRIPTION

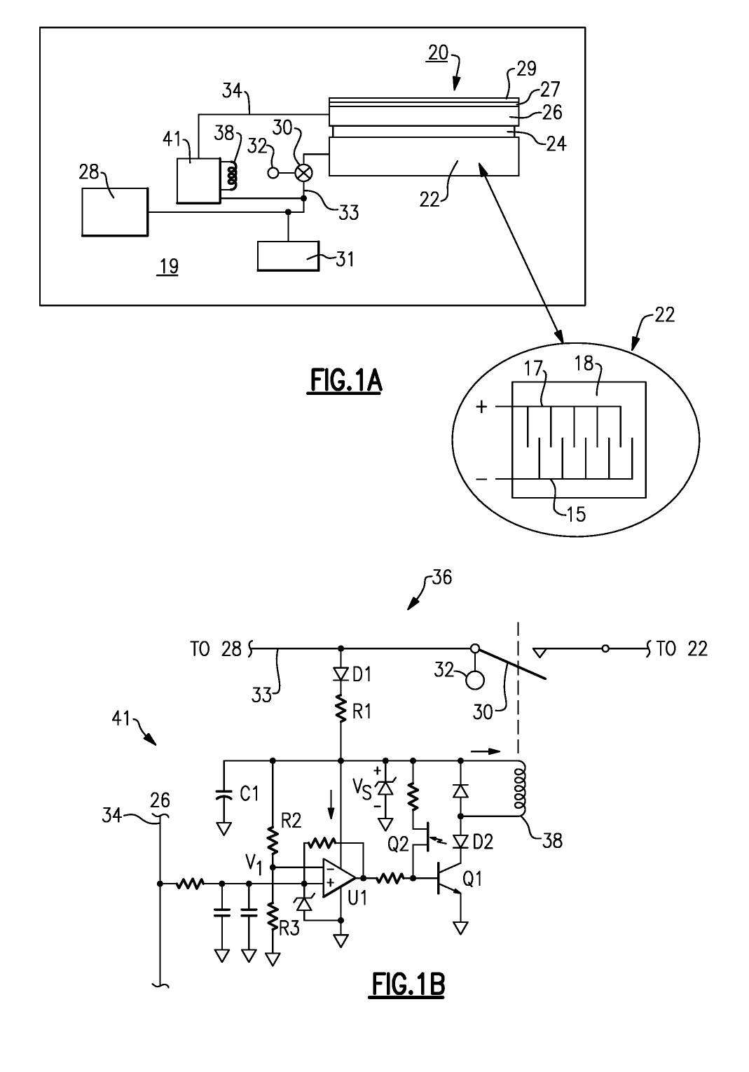

FIG. 1A shows an aircraft cabin 19 schematically. A heated floor panel 20 is located in an aircraft cabin. As an example, the heated floor panel 20 may be placed near an aircraft door. The heated floor panel 20 may be generally as known and include a heating layer 22 including conductors 15 and 17 and a substrate 18 of a PTC material that will heat when exposed to the current from conductors 15 and 17.

Heated floor panels are generally known. The heating layer 22 is formed of a substrate that may be any number of materials. As examples, a carbon-loaded silicone-based film may be utilized. Alternatively, an ink/paste layer may be utilized as the substrate. Further, a PTC material may coat a fabric. The spacing of the conductors is designed based upon desired heat-up rates, power density, and heating patterns. The PTC substrate is tailored through chemistry, thickness, length, etc. to control heater performance.

In general, a PTC heating layer is characterized as reaching a desired temperature. At the point it reaches its desired temperature, the resistance of the substrate increases greatly which will limit the flow of power to the heater. Thus, a PTC heating layer could be characterized as operating around a steady-state design temperature.

An insulating layer 24 separates the heating layer 22 from an electrically conductive layer 26. The layer 26 can be a guard screen or a film. The insulating layer 24 may be a dielectric material. Another insulating layer 27 and an outer skin 29 may be included.

Power is supplied from 28 to the heating layer 22. A control 31 controls the amount of current flowing through a supply line 33 to the heating layer 22.

A protection circuit 41 is shown mounted on supply line 33. A switch 30 is downstream of protection circuit 41. Protection circuit 41 may be provided with a transformer 38 that can operate an optical latch circuit 32 to open the switch 30 under certain conditions. As shown, line 31 communicates layer 26 to circuit 41.

FIG. 1B shows an example protection circuit 41. When current flows through the line 33, power from 28 energizes Vs through D₁, R₁, and C₁. A voltage V₁ is developed across R₃ for reference to U₁ minus an input. As shown, circuit 41 also communicates with layer 26 through line 34. If current flows into 26 (as explained below), then a conductive layer 26 voltage may exceed V₁. If so, U₁ will activate Q₁ and coil 38 which opens switch 30. Optical light from D₂ activates Q₂, latching Q₁ on, holding coil 38 active, and switch 30 open until power from 28 is removed. Any other circuit that can operate to open a switch should current flow in layer 26 may be utilized.

As long as the insulation layer 24 sits between the conductive layer 26 and heating layer 22, no voltage will exist on line 34. Under these conditions, the circuit 41 will not open the switch 30. Thus, the heated floor panel 20 can operate to heat a floor.

FIG. 2 shows damage 42 to the heated floor panel 20. Perhaps a knife or heavy object has been dropped on the panel. As shown, a point 44 exists where the conductive layer 26 is now in contact with the heating layer 22. This will cause current flow into conductive layer 26.

At such a point, the circuit 41 will see the voltage on line 34 and open the switch 30, as shown.

This will stop current flow from source 28 to the heating layer 22. Once power is shut off, the switch 30 will return to a closed position and the panel can be repaired or otherwise evaluated.

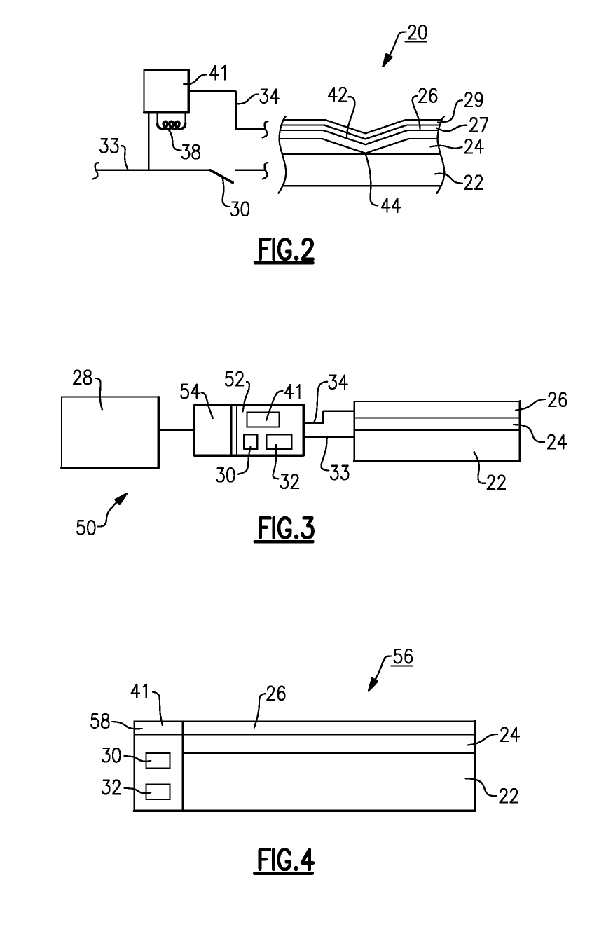

FIG. 3 shows a first potential location wherein the protection circuit 41, the switch 30, and the control 31 are all placed within a portion 52 of a connector that is connected at 54 to the power supply 28.

FIG. 4 shows an alternative embodiment 56 wherein a side compartment 58 receives the protection circuit 41, switch 30, and control 31.

While a heated floor panel is utilized, the protective benefits of this disclosure may extend to other PTC heater applications.

The protection features of this disclosure would benefit other type heating layers than just PTC heaters. Also, protection circuits that stop the supply of electrical energy to the heating layer in ways other than opening a switch may come within the scope of this disclosure.

Thus, the disclosure could be broadly stated as comprising a heater electrical short protection arrangement having a heating layer being at least partially electrically conductive. A conductive layer initially electrically insulated from the heating layer. A circuit in electrical communication with the conductive layer configured to halt a supply of electrical energy to the heating layer in response to current flowing into the conductive layer.

The disclosure also extends to a method of providing heat that includes supplying power to a heating layer that is at least partially electrically conductive and with a conductive layer electrically insulated from the heating layer. A circuit in electrical communication with the conductive layer, selectively stopping the supply of power to the heating layer should current flow into the conductive layer.

Although an embodiment of this invention has been disclosed, a worker of ordinary skill in this art would recognize that certain modifications would come within the scope of this invention. For that reason, the following claims should be studied to determine the true scope and content of this invention.

1. A heater electrical short protection arrangement comprising:
a heating layer being at least partially electrically conductive;
a conductive layer initially electrically insulated from the heating layer; and
a circuit in electrical communication with the conductive layer configured to halt a supply of electrical energy to the heating layer in response to current flowing into the conductive layer.

2. The arrangement as set forth in claim 1, wherein said heating layer having a positive coefficient material.

3. The arrangement as set forth in claim 2, wherein said circuit opens a switch to stop the supply of electrical energy.

4. The arrangement as set forth in claim 1, wherein said circuit opens a switch to stop the supply of electrical energy.

5. The arrangement as set forth in claim 4, wherein said protection circuit includes a transformer to open said switch if current flows into said conductive layer.

6. The arrangement as set forth in claim 4, wherein said switch is on a line connecting a power supply to said heating layer.

7. The arrangement as set forth in claim 1, wherein said conductive layer is a guard screen.

8. The arrangement as set forth in claim 1, wherein said conductive layer is a film.

9. The arrangement as set forth in claim 1, wherein said heating layer includes electric conductors and a substrate formed of a positive temperature coefficient material, and said heating layer having a design temperature and a resistance of said heating layer increasing when said design temperature is reached.

10. The arrangement as set forth in claim 1, wherein an insulating layer is included between said heating layer and said conductive layer.

11. The arrangement as set forth in claim 10, wherein said insulating layer is formed of a dielectric material.

12. The arrangement as set forth in claim 1, wherein if there is damage to said heating layer, said conductive layer may be forced into contact with a portion of said heating layer to supply current into said conductive layer, and cause said protection circuit to actuate said switch.

13. The arrangement as set forth in claim 1, wherein protection circuit is received in an electrical connector connecting said heating layer to a current supply.

14. The arrangement as set forth in claim 1, wherein said circuit is received in a compartment to one side of said heating layer.

15. The arrangement as set forth in claim 1, wherein said heater is a heated floor panel.

16. The arrangement as set forth in claim 15, wherein said heated floor panel is to be utilized in an aircraft cabin.

17. The arrangement as set forth in claim 15, wherein said heating layer includes electric conductors and a substrate formed of a positive temperature coefficient material, and said heating layer having a design temperature and a resistance of said heating layer increasing when said design temperature is reached.

18. A method of providing heat comprising:
supplying power to a heating layer that is at least partially electrically conductive, and a conductive layer electrically insulated from the heating layer;
a circuit in electrical communication with said conductive layer, selectively stopping the supply of power to said heating layer should current flow into said conductive layer.

19. The method as set forth in claim 17, wherein said circuit opens a switch.

20. The method as set forth in claim 18, wherein if there is damage to said heating panel, said conductive layer is forced into contact with a portion of said heating layer to supply current into said conductive layer, and cause said circuit to stop the supply of power to said heating layer.
